(19) United States
(12) Patent Application Publication
(10) Pub. No.: US 2025/0097255 A1
(43) Pub. Date: Mar. 20, 2025

(54) SYSTEM AND METHOD FOR ORGANIZING OPERATION OF A CLIENT-DIRECTED DISTRIBUTED NETWORK AND A NODE AND A CLIENT IN A CLIENT-DIRECTED DISTRIBUTED NETWORK

(71) Applicant: DANDELION NETWORKS INC., Toronto (CA)

(72) Inventors: Paul CHAFE, Toronto (CA); Dixin XU, Richmond Hill (CA)

(21) Appl. No.: 18/848,305

(22) PCT Filed: Mar. 17, 2023
(86) PCT No.: PCT/CA2023/050351

§ 371 Date: Sep. 18, 2024

Related U.S. Application Data
(60) Provisional application No. 63/321,357, filed on Mar. 18, 2022.

(51) Int. Cl. H04L 9/40

(52) U.S. Cl. CPC H04L 63/1441

(57) ABSTRACT

There is provided a distributed network and method for organizing operation of a distributed network, and a node and client for the distributed network. The method including: directing each client to communicate a request for state transition to the nodes; directing the nodes to evaluate the validity of each request received from each client; directing each node to change a state associated with the clients that sent the validated request to a pre-commitment state, and communicate to the client a signed acknowledgement that the request has been validated; directing the clients that received signed acknowledgments to collate all the signed acknowledgments received from the nodes; where the client has collated signed acknowledgments from at least a predetermined number of nodes, directing the client to communicate the collated acknowledgements to the nodes; and directing each node to advance the state associated with each client that communicated collated acknowledgements.

### TECHNICAL FIELD

The following relates to distributed systems; and more specifically, to a system and method for organizing operation of a client-directed distributed network and a node and a client in a client-directed distributed network.

### BACKGROUND

In some cases, creation and operation of distributed systems should have information and/or activities synchronized across a plurality of nodes. For example, networks that are used for fault tolerant computing, fault tolerant storage, and disaster resistance. Distributed storage systems, distributed databases, distributed ledger systems (such as blockchains), and distributed computing systems (including cloud computing and supercomputing systems) are examples of such systems.

### SUMMARY

In an aspect, there is provided a method for organizing operation of a distributed network, the distributed network comprising a plurality of nodes and a plurality of clients in communication, the method executed on at least one of a computing device of one or more of the nodes, a computing device of one or more of the clients, or another computing device, the method comprising: directing each client, which desires to transition a state associated with the client, to communicate a request for state transition to the nodes; directing the nodes to evaluate the validity of each request received from each client; directing each node, which has validated the request, to change a state associated with the clients that sent the validated request to a pre-commitment state, and communicate to the client, which communicated the validated request, a signed acknowledgement that the request has been validated; directing the clients that received signed acknowledgments to collate all the signed acknowledgments received from the nodes; where the client has collated signed acknowledgments from at least a predetermined number of nodes, directing the client to communicate the collated acknowledgements to the nodes; and directing each node to advance the state associated with each client that communicated collated acknowledgements from the pre-commitment state to a next state.

In a particular case of the method for organizing operation of a distributed network, the predetermined number of nodes comprises a sufficient majority as determined under a byzantine fault tolerant or asynchronous byzantine fault tolerant consensus scheme.

In another case of the method for organizing operation of a distributed network, a history of states for each client is recorded in a cryptographically linked hash chain, merkle structure, or graph.

In yet another case of the method for organizing operation of a distributed network, the state of each client is maintained on at least a portion of the nodes based on a token account.

In yet another case of the method for organizing operation of a distributed network, state transitions are charged against the token account at a fixed rate or at a rate based on computing work or resources.

In yet another case of the method for organizing operation of a distributed network, the nodes are assigned into shards, each shard maintaining states for a subset of the clients of the distributed network.

In yet another case of the method for organizing operation of a distributed network, where state transitions are divided into sending and receiving halves, and wherein the receiving halves are buffered on the nodes against the state of the client that is desirous to transition the state.

In yet another case of the method for organizing operation of a distributed network, directing the nodes to evaluate the validity of each request received from each client comprises using an ACID (atomicity, consistency, isolation, durability) paradigm.

In yet another case of the method for organizing operation of a distributed network, the state transitions can include Precommit, Preabort, Update, Commit, or Abort.

In another aspect, there is provided a method for operating a node on a client-directed distributed network, the node executed on a computing device, the method comprising: receiving a state transition request associated with a client on the distributed network; evaluating the validity of the request received from the client; where the request is valid, changing a state associated with the client to a pre-commitment state, and communicating a signed acknowledgement that the request has been validated to the client; receiving, from the client, collated acknowledgements from at least a predetermined number of nodes; and advancing the state associated with the client from the pre-commitment state to a next state.

In a particular case of the method for operating a node on a client-directed distributed network, the predetermined number of nodes comprises a sufficient majority as determined under a byzantine fault tolerant or asynchronous byzantine fault tolerant consensus scheme.

In another case of the method for operating a node on a client-directed distributed network, state transitions are charged against a token account associated with the client at a fixed rate or at a rate based on computing work or resources.

In yet another case of the method for operating a node on a client-directed distributed network, the node is assigned a shard, where each shard maintains states for a subset of the clients of the distributed network.

In yet another case of the method for operating a node on a client-directed distributed network, where state transitions are divided into sending and receiving halves, and wherein the receiving halves are buffered on the node against the state of the client.

In yet another case of the method for operating a node on a client-directed distributed network, evaluating the validity of the request comprises using an ACID (atomicity, consistency, isolation, durability) paradigm.

In yet another case of the method for operating a node on a client-directed distributed network, the state transitions can include Precommit, Preabort, Update, Commit, or Abort.

In another aspect, there is provided a method for operating a client on a client-directed distributed network, the client executed on a computing device, the method comprising: where the client desires to transition a state associated with the client, communicating a request for state transition to nodes on the distributed network; received a signed acknowledgement that the state transition request has been validated from a plurality of the nodes; where signed acknowledgments have been received from at least a predetermined number of nodes, collating the signed acknowledgments received from the plurality of nodes; and communicating the collated acknowledgements to the nodes to advance the state associated with the client to a next state.

In a particular case of the method for operating a client on a distributed network, state transitions are divided into sending and receiving halves, and wherein the receiving halves are buffered on the nodes against the state of the client.

In another case of the method for operating a client on a distributed network a history of states for each client is recorded in a cryptographically linked hash chain, merkle structure, or graph.

In another aspect, there is provided a distributed network comprising nodes and clients, the distributed network organized in accordance with the above.

These and other aspects are contemplated and described herein. The foregoing summary sets out representative aspects of systems and methods to assist skilled readers in understanding the following detailed description.

### DESCRIPTION OF THE DRAWINGS

An embodiment of the present invention will now be described by way of example only with reference to the accompanying drawings, in which:

FIG. 1 is a diagram of a system for organizing operation of a client-directed distributed network, according to an embodiment;

FIG. 2 is a diagram of an organizing system, according to an embodiment and according to the system of FIG. 1;

FIG. 3 is a flowchart for a method for organizing operation of a client-directed distributed network, according to an embodiment;

FIG. 4 is a diagram illustrating a state machine that moves from an initial State 0 to State 1, in accordance with the systems of FIGS. 1 and 2;

FIG. 5 illustrates an example of communications between a client and a set of nodes as the client leads the nodes through a transaction sequence, in accordance with the systems of FIGS. 1 and 2; and

FIGS. 6A and 6B illustrate a flowchart of an example sequence for a negotiated transaction, in accordance with the systems of FIGS. 1 and 2.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any module, unit, component, server, computer, computing device, mechanism, terminal or other device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media and executed by the one or more processors.

The following relates to distributed systems; and more specifically, to system and method for organizing operation of a client-directed distributed network and a node and a client in a client-directed distributed network.

Distributed computing generally includes an architecture with a client-server model. Servers maintain state, complete requested transactions, and provide requested state data. A state can be considered the total set of data stored on a node, and a transaction can be considered any update to the state allowed by the set of rules governing transactions. In non-limiting examples, rules may include:
Restricting a given client to updating the subset of state associated with its client ID.
Requiring that a transaction be atomic; meaning each transaction is either finalized in its entirety or fails in its entirety.
Requiring that a transaction be consistent.
   For example, a transaction that moves a data element from one list to another must both remove the element from the first list and add it to the second list. In such example, it will not be possible to remove an element without adding an element elsewhere, nor to add an element without removing one elsewhere. A transaction may be required to maintain a stable balance, such that the sum total of quantity remains the same, even as the distribution of the sum changes. There may be a local or global total which must remain within certain bounds, or the like.

Other rules than the above are possible and the above should not be taken to be exhaustive.

In general, a transaction is completed through a state machine, which ensures the rules are followed. The state machine transitions a series of substates in order to advance the global state from one finalized transaction to the next.

In constructing client-server architectures, there are many applications where it is desirable for the server to co-ordinate or synchronize data or system state across a plurality of computing nodes in a network, which then acts in aggregate as a server. This can be done to, for example, ensure fault tolerance, distributed trust, data redundancy, computational continuity, operational reliability of systems, and the like. Typically, these networks can perform both computation and storage functions, with data (state) being replicated across the nodes as operations progress. This co-ordination generally results in multiple, identical copies of a dataset being stored on distinct nodes, such that failure of a node or subset of nodes does not prevent the continued operation of the distributed system as a whole, result in data loss, or in erroneous or incorrect states.

The distributed network of the type described above can be considered the server in a client-server arrangement, even as the nodes it is composed of are themselves individual servers or processing units and may themselves be constituted of a plurality of sub-servers and/or sub-nodes. These nodes may be integral subcomponents of a single physical instantiation of the system, as in a single computing chip containing a plurality of processors, or physically separated to an arbitrary degree, as for example with separate servers within a datacentre, or individual nodes at distributed geographic locations. The primary requirement is that they be connected by some kind of communications channel.

The complete network may be subdivided into shards, each of which stores a separate subset of the complete system state, and which may act independently on this subset. In general, shards may communicate with each other to complete operations which require state updates and/or state changes to more than one shard. Sharding enables parallel operations to be completed by the network.

In the context of the network providing services, a client is a device(s) that is able to make service requests of the network, either as a whole or of individual shards. Such requests may be for updates on the current state of the network, or a portion of its state, for example requesting the value of a particular entry in a distributed ledger or database. Alternatively, such clients may request that the network change its state through any one of a set of allowed transitions. These requests may result in further actions taken by the network, which are determined by its state.

It is desirable that distributed networks have properties of liveness and safety. Liveness in this context means that all clients that make a valid state-change request to the network will eventually see that request satisfied. Safety in this context means that no invalid state-change requests are ever executed and that all valid state-change requests produce consistent results. A stricter definition of safety requires that all state update requests return the most recent state of the network. In practice, more sophisticated definitions of safety and liveness can be used. No networks can be guaranteed perpetual liveness in the face of unbounded failures, and networks must have their safety mechanisms carefully considered to prevent both deadlocks (two or more clients attempting mutually exclusive operations simultaneously) and livelocks, both of which result in liveness failures. Both safety and liveness may be defined deterministically or probabilistically.

The PACELC theorem defines a trade-off between availability (A) and data consistency (C) in the case of a network partition (P) (i.e., where a node or nodes are unable to communicate with the remainder of the network), elsewise, (E) a trade-off between latency (L) and consistency in the case of normal network operations. These two conditions can be seen as part of the same spectrum, where an availability failure can be seen as infinite increase in network latency when a network partition happens in a network where data consistency is required. The trade-offs cannot generally be avoided; however, different trade-offs can be made depending on the relative value of consistency and availability in a particular application.

While simple in principle, distributed networks are complex in practice, requiring the network to tolerate not just simple faults but byzantine or adversarial behaviour. Such behaviour can be defined as any fault which may occur, or any behaviour an adversary is capable of producing that is aimed at disrupting the network or creating states not intended or not desired in normal network operation. At the communications channel level, adversarial behaviour can include modifying, delaying, redirecting, or blocking messages between nodes, as well fabricating messages. An adversary may also capture and control a certain subset of nodes. In some schemes, despite the presence of byzantine nodes, the network attempts to not produce errors so long as a sufficient majority of nodes do not operate disruptively. A node simply going offline or suffering communication delays does not count as acting disruptively. In networks prioritizing consistency, if too many nodes failing in non-adversarial ways (e.g., going offline, suffering message delays, or random message errors), the network will simply stall. It will not advance its state, but it will still not be possible to introduce errors or lose data. In networks prioritizing availability, data will still be returned, but there can be no guarantee that it 13 represents the most recent state of the network.

In general, networks of this type employ a consensus protocol to determine the state of the network, with the nodes determining the network consensus for each state transition before updating their own internal state. This consensus may be deterministic (the system has either definitely transitioned to the next state, or it definitely has not) or probabilistic (a client or node can estimate the probability that a state transition has occurred, and considered that it has occurred once this estimate passes a certain threshold). This consensus protocol is carried out by message passing between nodes which serves to update them on the state of individual nodes, which in turn informs them of the global state of the internet. Broadly, there are two classes of consensus protocol, leader-based and leaderless.

Leader-based approaches may simply designate one node to perform updates, or use an election or nomination system to choose this node; for example, by discrete consensus round, by time interval, on recognized failure of the current leader, or by other criteria. This choice may be random or involve various voting systems. In all cases, the leader orchestrates each state update across the follower nodes, and is usually responsible for receiving state-change requests from clients. The leader may also be responsible for reporting the current state of the system back to clients, as it knows when a sufficient majority of nodes have confirmed updates. Alternatively, clients may request state updates from nodes, with some criterion to determine if the update is the most current. Leader based approaches have efficient communications, with the message load generally scaling proportional to N, the number of nodes on the network. However leader based systems require all state changes to be handled by the leader, and so are inherently serial in execution, which can bottleneck operations. Further, an adversarial node can target the leader for disruption. When the other nodes identify that the leader fails, a new leader will be nominated, however an adversarial node will learn the new leader through the selection process, and will be able to target it as well, disrupting the network with a minimal resource investment. In addition to these vulnerabilities to external adversaries, the leader may have freedom to influence the operation of the system, while not actually acting in a byzantine way. For instance, the leader in a blockchain system is typically responsible for choosing the contents of each block before it is linked into the blockchain. Where the order of block entries matters, as in certain transactions, the leader may preference itself.

Leaderless approaches determine consensus as a network wide behaviour, with nodes updating and/or sampling other nodes to communicate knowledge of the current state of the network, using random gossip or other communication protocols to do so. Clients in this case may make a request to any operational node, either to request a state-change or to request an update on the current state. Leaderless approaches are generally more robust than leader- based systems, are not vulnerable to targeted attacks on the leader, and are not vulnerable to leader manipulation. As all events are not filtered through the leader, it is possible to achieve parallel execution for independent state updates. However, their message load generally rises proportionally to N², where N is the number of nodes on the network. As message load increases, network performance decreases, and communications costs rise. This imposes strict limits on the number of nodes the network can support before it becomes too slow or too expensive to operate.

In cases where security and identity are important, cryptographic systems may be used to protect messages in transit on the communications channels between clients and server and between nodes and other components of the server network. They may also be used to authenticate the identity of nodes and clients.

Generally, systems offering distributed consensus mechanisms can use one of a number of different consensus mechanisms. For example, Hashgraph can be used; such as those described in U.S. Pat. Nos. 10,025,797, 10,198,469, 10,512,946, 10,839,025, 10,722,772, and 11,099,594. In another example, Algorand can be used; such as those described in U.S. Pat. Nos. 10,946,620 and 10,702,893. In another example, Avalanche can be used; such as those described U.S. Pat. Nos. 10,771,085, 10,747,001, 10,771,081, and 10,794,347. In another example, Tendermint can be used; such as those described in U.S. Pat. Nos. 10,741,688, 10,855,864, 10,526,693, and 10,570,111.

The present embodiments advantageously allow for the creation and operation of a distributed network of nodes, demonstrating advantageous safety and liveness properties; which is both highly efficient in the style of leader-based systems and resilient to attacks in the style of leaderless systems. The present embodiments also generally provide network load that is static for the nodes. Specifically, when used with appropriate cryptographic signature schemes, the network throughput is constant regardless of the number of nodes in the network, and the client load scales only linearly with the number of nodes. The nodes process all the transactions in the network, subnetwork or network shard, while the clients process only a small fraction; thus, the total network throughput is generally limited only by the bandwidth and computation power of the nodes.

Additionally, the present embodiments advantageously allow for the concurrent completion of separate state-changes, where such state-changes are independent of each other; which enables parallel operation when paired with an appropriate data structure and computing paradigm. Parallel operation allows many operations to be completed at once, and generally, each client is capable of leading state transitions simultaneously; generally limited only by the available bandwidth. The present embodiments can be used for operation of, for example, a server for a distributed ledger or database, a transaction clearance network, and a secure distributed computing; amongst other applications.

The present embodiments take advantage of the fact that there are two kinds of faults in networks of this type. Positive faults are those in which a requested transaction fails to complete even though it is valid, and negative faults are those in which a requested transaction completes, even though it is invalid. The above is used to define a network in which individual clients act as network leaders for their own transactions. This is made possible by the observation that clients are generally only motivated to request a transaction that they want to see complete. Such clients generally do not request a transaction that they do not desire. Thus, clients can be expected to act to complete any transition that it requests, and positive faults will eventually clear despite network interruptions or other failures. Simultaneously, negative faults are prevented by requiring the consensus of a majority of the nodes on the network that a client's requested transaction is in fact valid.

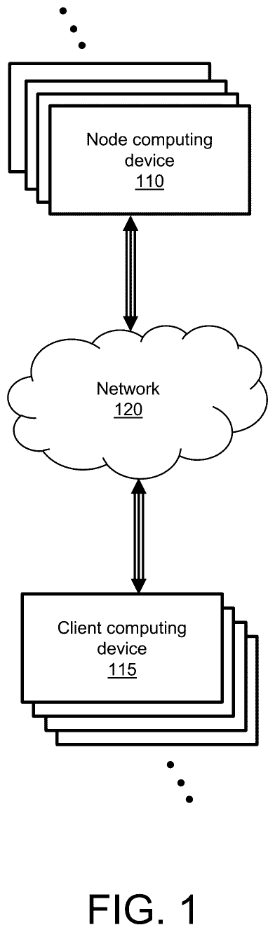

FIG. 1 shows a diagram of an embodiment of a client-directed distributed system 100 that includes a plurality of node computing devices 110 interconnected by a network 120 of communication links. Over the network 120, the node computing devices 110 are in communication with a plurality of client computing devices 115. Generally, the node computing devices 110 attempt to maintain a stable connection to the network 120, while the connection to the network of the client computing devices 115 can be more transitory. The network can be any suitable communication architecture; for example, the Internet, a wide-area-network, a local-area-network, a mobile communication structure, or the like. The communication links may be any suitable communication approach. While the present disclosure may refer to actions, functions, and decisions undertaken by the nodes 110 and clients 115, it is to be understood that this notation is shorthand for instructions undertaken by the computing devices of the nodes 110 and clients 115, respectively.

The node computing device 110 and the client computing device 115 can each be run on a single computing device; for example, a desktop computer, a laptop computer, a tablet, a smartphone, a wearable device, an internet-of-things (IOT) device, a server, a dedicated piece of hardware, or the like. In further embodiments, the functions of each device 110, 115 can be run on multiple devices. In other embodiments, the components of each device 110, 115 can be distributed among two or more computing devices.

In some cases, the functions of the node computing device 110 and the client computing device 115 can be executed on the same hardware and computing device.

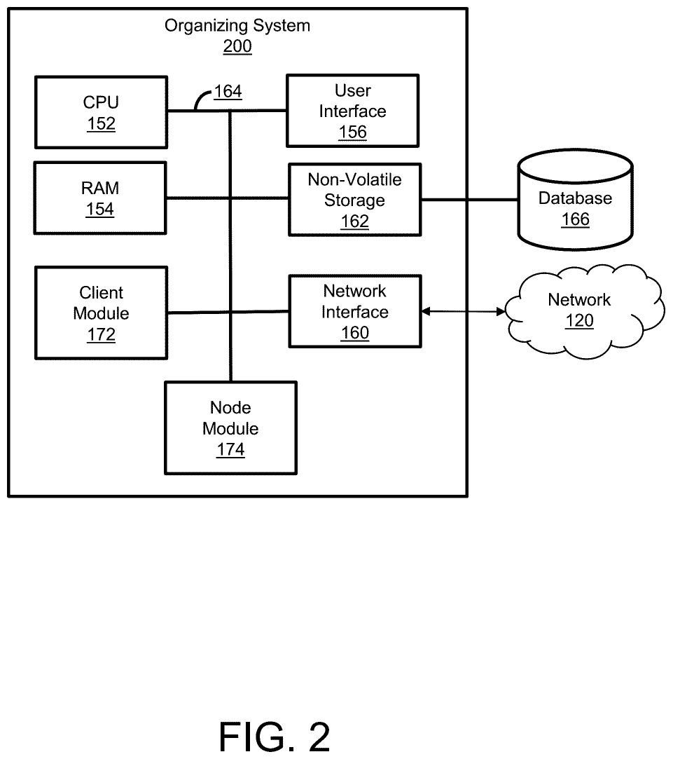

Turning to FIG. 2, an embodiment of an organizing system 200 within the client-directed distributed system 100, is shown. The organizing system 200 can be, or part of, the node computing device 110, the network computing device 115, or a separate computing device communicating over the network 120. In this embodiment, the organizing system 200 is run on a single computing device. In further embodiments, the functions of the device 110 can be run on multiple devices. In other embodiments, the components of the device 110 can be distributed among two or more computer systems that may be locally or remotely distributed; for example, using cloud-computing resources.

FIG. 2 shows an example of various physical and logical components of the organizing system 200. As shown, the device 200 has a number of physical and logical components, including a central processing unit (“CPU”) 152 (comprising one or more processors), random access memory (“RAM”) 154, a user interface 156, a network interface 160, non-volatile storage 162, and a local bus 164 enabling CPU 152 to communicate with the other components. RAM 154 provides relatively responsive volatile storage to CPU 152. The user interface 156 enables an administrator or user to provide input via an input device, for example a mouse or a touchscreen. The user interface 156 also outputs information to output devices; for example, a display. The network interface 160 permits communication with the network 120 or other computing devices and servers that are remotely located. Non-volatile storage 162 stores the applications and modules, including computer-executable instructions for implementing the applications and modules, as well as any data used by these services. Additional stored data can be stored in a database 166. During operation of the system 150, the operating system, the modules, and the related data may be retrieved from the non-volatile storage 162 and placed in RAM 154 to facilitate execution.

In an embodiment, the organizing system 200 further includes conceptual modules to be executed on the one or more processors 152, including a client module 172 and a node module 174. In further cases, the functions of the conceptual modules can be combined or executed as part of other modules

The distributed system 100 generally requires both node computing devices 110 and clients 115 to be individually identifiable as the originators of state transition messages, and that the messages requesting or approving state transitions themselves be authenticable. In some cases, a strong cryptographic signature scheme will achieve this. Generally, cryptographic signature schemes require the use of matched key pairs. These consist of a key K_{P}, made generally available to verifiers, and a secret key, K_{S}, known only to the message originator. A message is then signed using the appropriate cryptographic signature algorithm and K_{S}. This produces a unique digital signature which can then be verified against the message using the associated cryptographic verification algorithm and K_{P}. Examples include RSA™, Boneh-Lynn-Shacham (BLS), Falcon™, and others. While aggregable cryptographic signature schemes are preferred, it is understood that such schemes are not required.

As nodes 110 never have to communicate directly to complete transactions across the network, and as the clients 115 perform the coordination function between nodes 110, it is the clients 115 who carry the majority of the communications burden, by a factor proportional to N, the number of nodes 110 on the network. As it is more cost effective to provide high bandwidth connections to a relatively smaller number of nodes 110 than to a large number of clients 115, the system 100 can efficiently be scaled in both node count and speed. The system 100 as a whole can handle many times more transactions than an individual client 115 can generate, and this factor increases with the number of nodes 110 on the network. Clients 115 can improve individual performance by upgrading their individual bandwidth links. This separation allows independent optimization of, for example, transaction time and transactions per second. Transaction time is the amount of time required for an individual client 115 to complete a transaction across the nodes 110 of the system 100, where a transaction is proportional to N and the individual client's bandwidth. Transactions per second is the total number of state transitions the system 100 can complete as a whole, and is proportional to the bandwidth of the median node, or lower-half median node, or the like; depending on the choice of fraction necessary for a sufficient majority. Advantageously, transactions per second is independent of N; which differs from other approaches where communications complexity scales with N (in the case of most leader-based systems), or N\hat{ }2 (in the case of most leaderless systems). Advantageously, transactions per second can scale both with technological advances in bandwidth capacity and with the general trend for increased connectivity.

In some cases, for open configurations, an appropriate incentive scheme can be applied to encourage nodes 110 to invest in bandwidth above, for example, the median, above the lower half median, or the like. This incentive enables the system's 100 capabilities to advance with technology, without specifically mandating any given node upgrade its hardware.

In some cases, each node 110 can record the state of each client 115. When a client 115 wishes to complete a transaction, a request for the transaction is communicated to a majority of the nodes 110 on the network. Each node 110 independently verifies the validity of the requested transaction. If it is valid, the node 110 enters a locked state, informally referred to as ‘Precommit’, in which the node 110 will accept no other transaction requests; and in some cases, returns a cryptographically signed message attesting to this locked state. When the client 115 has received attestations from a majority of nodes 110, it collates them and returns the collated list to the nodes. Each node 110 then has cryptographic proof that a majority of the nodes 110 are in this state, and can then advance the state of client 115 to the requested state.

As a majority of nodes 110 are provably locked prior to the advance of the client's state on any one node 110, the client 115 may only process future transactions by advancing the state of a majority of nodes 110. In some cases, this approach can be carried out by a state machine associated with each client on each node 110, whereby a transition of the client's state is carried out by advancing the state of the state machine through the substates described herein. In most cases, the state machine will have further states and transitions which allow for partial failures and other error states to be corrected while maintaining correctness.

The system 100 may be used to build a general purpose distributed computing platform that is capable of carrying out arbitrary computations, storing arbitrary data, and performing arbitrary communications. In cases where each client 115 is only responsible for its own state transitions, the system 100 operates as a parallel system, with a degree of parallelism equal to the number of clients 115 and a total throughput is proportional to the bandwidth of the median node 110 on the network. Generally, state transitions are completed as a whole when they have been completed on a majority of the nodes 110 in the system 100.

In cases where it is desirable to have one client's state transition change the state of another client, as for example in a balance transfer from one client to another, the transition can be decoupled into two parts, referred to as outgoing and incoming transaction halves. These can be considered, respectively, as ‘clear’ and ‘settle’ halves.; where elements of the transaction are first cleared in the sender's account before being settled in the receiver's account. This is arranged by adding a buffer to hold incoming transactions to each client's state. In order to finalize a complete transaction, the outgoing (clear) half is first completed by the sending client in the manner described above. Part of this transaction will generally include the address of the intended receiving client. When the outgoing (clear) half has completed, the incoming (settle) half of the transaction is written to the receiving client's incoming transaction buffer. This buffer, associated with each client's state on every node, holds a list of such half-transactions which have cleared on the sending client's side.

In general, many initiating clients may simultaneously send such outgoing transition halves aimed at a single receiving client. As these initiating clients will not, in general, contact the nodes of the network in the same order or with any synchronization, the order of receipt of these transitions at individual nodes will be different. The contents of the inbound buffer may therefore, not be consistent with each other. In order to maintain consistency of client state across all the nodes of the network, these buffered transactions are completed in a specific sequence; which is shared by all nodes. To achieve this sequence, the receiving client chooses a specific single transaction present in the buffers to be finalized into its internal, ordered state, and then advances it through the state machine in the same process used in the first half of the transaction. The result is that the chosen transaction is ‘settled’ onto the target client's state. At which time the transaction can be considered complete.

In this way, transaction sending and receiving can be decoupled and may proceed asynchronously. That is, a transaction can be initiated by the sending client at one time, and completed by the receiving client at another time.

In some cases, transactions can be completed by, for example:
Having the sender notify the receiver that a transaction has been cleared and may now be settled. This will generally require a direct connection between sender and receiver.
The receiver may connect to the network at intervals, check the buffers for any incoming transactions at those times, and then settle the transactions. This generally does not require any contact between the sender and receiver.
The clients may independently agree to allow either the receiving client to manage both the clear and settle halves of the transaction, by using the cryptographic signature of the sender to authorize this transaction approach. This approach allows a receiver client with higher bandwidth or better connectivity to manage both clear and settle halves of the transaction.

In some cases, where it is desirable to allow a client to commit a series of sequential state transitions, all of which are allowable under the system's ruleset, this entire series may be aggregated into a single message; which can be processed using a single signature exchange sequence as detailed herein.

In some cases, where the order of execution matters and where it is undesirable to have the receiving client determine this order, an ordering scheme may be used to determine the order. Such a scheme may be implemented by having each node 110 record the order in which it receives incoming state transition requests in its local copy of the incoming transaction buffer. This ordering is transmitted with transition confirmations to the receiving client and, when collated by the receiving client, these individual orderings may then be used to determine the overall order by using an appropriate ranking scheme. In order to ensure that individual nodes cannot influence the final ranking, the system 100 may consider only the first half of the nodes 110 to respond with an ordering. This approach prevents nodes that delay responses from having an impact on the final ordering. The system may also use the median response of the sampled responses, which removes the ability of any individual node to influence the result by changing its individual order. Ranked pairs and/or similar voting systems may be used, and ties may be resolved using, for example, a verifiable random function (VRF) with parameters known to the nodes.

Although client state transitions are led by clients 115 without requiring direct internode communications, it will in general be necessary for nodes 110 to co-ordinate with each other to determine network operating parameters, (for example, to determine N, to determine the parameters used in VRF, to exchange K_{P}, node address lists, and the like). This may be arranged using any suitable consensus or co-ordination approach. In the case of node-to-node coordination, this will impose a communications load proportional to N, N*log(N), or N\hat{ }2, depending on the type of communications. However, such coordination can be performed rarely compared to network state transitions, and thus, do not take up an appreciable fraction of network bandwidth, even as N grows large.

In some cases, network operating parameter communications can piggyback on client state transition messages. In these cases, node-side communication burden scales with N. In these cases, it is necessary to ensure that sufficient nodes are included in client side broadcasts.

In some cases, client state can be updated through network co-ordination rounds, where the nodes 110 find consensus on a desired state transition for a given subset of stored state through the co-ordination round process.

An example application of the system 100 is to maintain a robust distributed database. Such a database may be structured to conform to the Atomic, Consistent, Isolated, Durable (ACID) paradigm required to guarantee data validity in the face of errors. Another example application of the system 100 is the maintenance of a distributed ledger in which the transaction or state history for each client is recorded in a cryptographically linked hash chain, merkle tree, graph, or similar data structure. Inter-client transactions may be created by bridging the clear and settle halves of a transaction between client chains as described herein. Another example application of the system 100 is the performance of arbitrary computing tasks. Another example application of the system 100 is in an environment of distributed trust; i.e., a computing environment where no individual node or sub-majority coalition of nodes is able to prevent the advance of state, the recording of transactions, or the execution of code.

The system 100 may be operated as an open or closed system. In a closed system, network membership is established by the granting of node identity by some authority, through the issuance of a recognized cryptographic key pair, or other suitable approaches. In an open system, network membership is determined by an algorithm which is executed by the existing nodes in order to determine network consensus on the admissibility of a new candidate node. In this case, the algorithm may measure physical or other characteristics of candidate nodes to establish their admissibility; where any measurable characteristic may serve for this purpose.

In some cases, the system 100 may operate on a token-toll basis; where part, or all, of a client's state that is maintained on the nodes uses a token balance/account. In some cases, this digital token can be unique to the network and can be created through cryptographic proof-of-work, proof-of-stake, other proof protocol, or other approach. State transitions are charged against this token balance at a rate which may be fixed, may be determined algorithmically, or which may be determined via consensus of the nodes. Inputs to the rate determination may include, for example, network load levels. A token charge rate which is set to increase with network load levels can act to prevent malicious congestion of the network, as the token cost to an attacker will rise in proportion to both the transition request volume required to cause network congestion and with the token rate charged for each transition. This demand response curve can be linear, sublinear, superlinear, sigmoid, or otherwise structured to provide the desired rate response characteristics in response to network load. In these cases, tokens can be produced either arbitrarily or externally, or as part of the operation of the network; in which case they may be provided to nodes according to an applicable algorithm. Such an algorithm may determine node token issuance in whole or in part according to the level of participation by the node in the network; where participation may be measured by bandwidth, uptime, completed state transitions, or the like. Such an algorithm may also be governed by other parameters accessible to the nodes on the network, including, token use rate, volume, transaction size, or the like.

In some cases, the nodes 110 can be configured to exchange the digital tokens between different identities established on the network. The nodes 110 may be configured to create, issue, and exchange the digital tokens for arbitrary transaction settlement. The nodes 110 may be configured to exchange the digital tokens for a given amount of computing work. The digital tokens may be exchanged for a given amount of computing work according to a predetermined ‘price’ for the computing work and resources. In other cases, the digital tokens may be exchanged for a given amount of computing work or resources according to an automated market based on user settable prices for such work and resources.

The separation between client and node is particularly advantageous. In particular embodiments, a node stores states and manages the state machine which governs state transitions on the state or states stored. Clients can lead state transitions by assembling the consensus of a majority of nodes on the current and desired state. In this way, in some cases, the same computing device acting as a node may also act as a client. This unity can be achieved by using the same public/private keypair to perform both functions, or by using separate public/private keypairs.

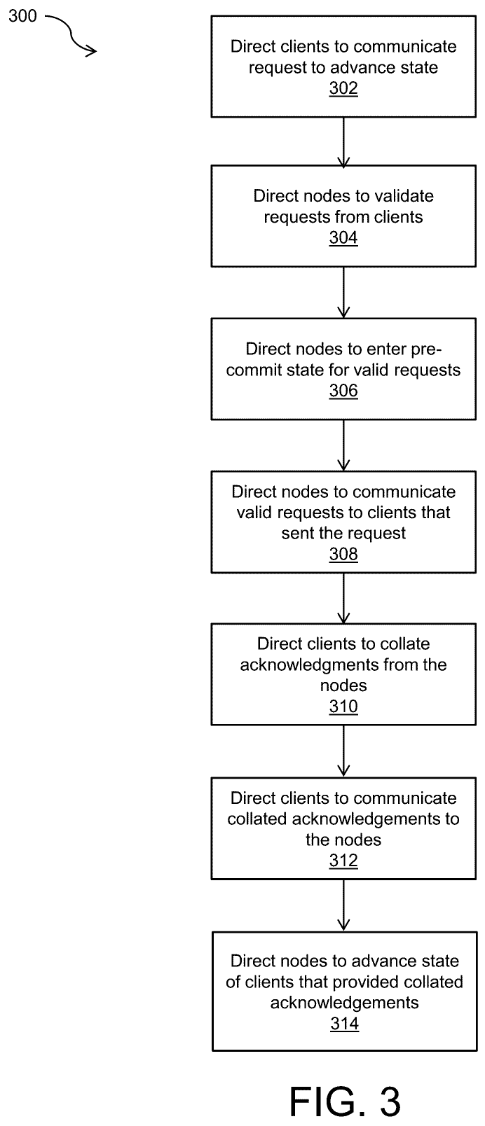

FIG. 3 is a flowchart diagram of a computer-implemented method 300 for organizing operation of a client-directed distributed network, according to an embodiment. At block 302, the client module 172 directs each client computing device 115 on the distributed network, which desires to transition its state to communicate requests for state transitions to all, or a significant portion, of the node computing devices 110 on the distributed network.

At block 304, the node module 174 directs the node computing devices 110 to evaluate the validity of each request received from each client computing device 115. In an example, validity can be determined using an ACID (atomicity, consistency, isolation, durability) paradigm, or any other suitable approach. In cases where a given node computing devices 110 has not previously received a request from a given client computing device 115, the node module 174 directs such node computing device 110 to generate a state machine associated with such client computing device 115.

At block 306, the node module 174 directs each node computing devices 110 that has validated the request to change the state machine associated with the client computing device 115 that sent the validated request to a pre-commitment state.

At block 308, the node module 174 directs each node computing device 110, upon validating the request, to communicate to the client computing device 115 that sent the validated request a signed acknowledgement that the request has been validated and the node computing device 110 is prepared to complete the state transition.

At block 310, the client module 172 directs the client computing devices 115 that received signed acknowledgments validating their requests to collate all the signed acknowledgments such client 115 received from the node computing devices 110.

At block 312, where a given client computing device 115 has collated signed acknowledgments from at least a predetermined number of node computing devices 110 on the distributed network, the client module 172 directs such client computing device 115 to communicate the collated acknowledgements to the node computing devices 110 on the distributed network. The predetermined number of node computing devices 110 can be any suitable amount; for example, more than 40% of the node computing devices 110 on the distributed network, more than 50% of the node computing devices 110 on the distributed network, more than 60% of the node computing devices 110 on the distributed network, or the like. In some cases, the predetermined number of node computing devices 110 can be a sufficient majority as determined under a byzantine fault tolerant (BFT), or asynchronous byzantine fault tolerant (ABFT), consensus scheme.

At block 314, the node module 174 directs each node computing device 110 to advance the state machine associated with each client computing device 115 that provided collated signed acknowledgments from the pre-commitment state to the next state.

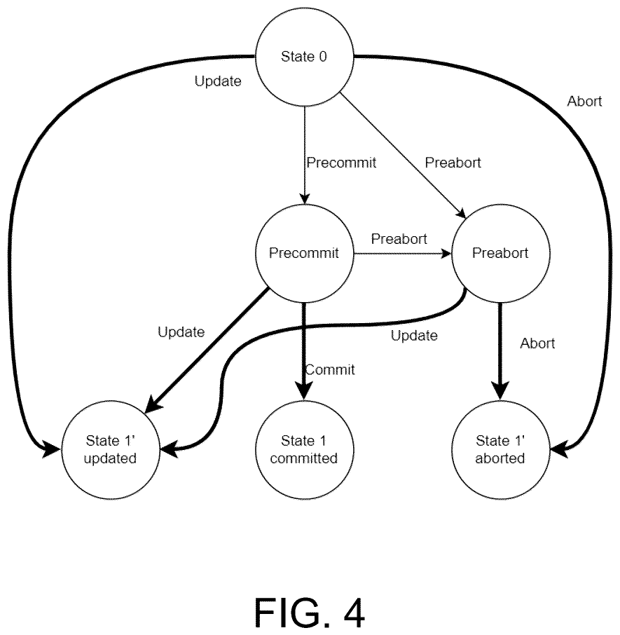

FIG. 4 illustrates a state machine that moves from an initial State 0 to State 1. In most cases, each client 115 has a state machine executed on its respective computing device. In a particularly simple advance of states, the transaction number is incremented from 0 to 1 with no other change. The transaction number is uniquely associated with each client 115 and can only increment. Thus, for a given client 115, State 0 advances to State 1, State 1 advances to State 2, and so on.

In advancing the state machine, the client 115 can issue requests for state transitions; which can include, for example, Precommit, Preabort, Update, Commit, or Abort. To increment the transition number, the state machine can follow state paths from State 0 to Precommit to State 1 (committed). It can move from State 0 to Precommit to Preabort to State 1 (aborted). It can move from State 0 to Preabort to State 1 (aborted), and it can move to State 1 (updated) from any state. State 1 (committed), State 1 (aborted), and State 1 (updated) all increment the transaction number from 0 to 1; however, other data associated with the client can be handled differently, as described herein.

The Preabort and Precommit requests require only the client's cryptographic signature on the request. The Update, Commit and Abort are requests that require the collated signatures of a majority of nodes on the network attesting that they are prepared to make the same transition. Such requests also include the signature of the client.

On receipt of a Precommit request, the node 110 in receipt determines the validity of the requested transition; for example, using an ACID (atomicity, consistency, isolation, durability) paradigm. If it is valid, the state machine of the node 110, for the respective client, enters the Precommit state and communicates an authentication of this state to the respective client 115 as a cryptographic signature. In the Precommit state, the requested transition is stored and the node awaits commitment or abortion. The node 110 will no longer accept Precommit requests from that client 115 until the current requested transaction is committed or aborted, or it receives a valid update request. The client 115 then collates Precommit signatures from a predetermined number of nodes 110; for example, not less than a majority of nodes 110. The client 115 communicates these signatures to each of the nodes 110 along with a Commit request. The state machine for such client 115 at each node 110 verifies these signatures and, if valid, completes the transition to State 1 (committed). In this state, the transaction number at the nodes 110 is incremented. This transaction number increment is the minimum possible change to the state of the client 115 that is allowed by a complete transition of the state machine.

In some cases, at a node of the network 110, further data can be held that is associated with the client 115. This data may also be updated according to the specifics associated with the Precommit request.

In some cases, the client 115 may opt to abort the state transition; for example, if network conditions impose a delay on obtaining Precommit signatures from a sufficient number of nodes during which external conditions change such that the requested state transition is no longer desired. In these cases, the client 115 can send a Preabort request to the nodes 110. On receipt of an authenticated Preabort request, each node 110 verifies the validity of the request and moves the state machine into the Preabort state, if it is not already there, and sends a cryptographically signed authentication to the client 115 as confirmation. The client 115 then collates the Preabort signatures from a predetermined number of nodes 110, for example from a majority of nodes, and communicates the collated list to each of the nodes 110. On receipt of this communication, each receiving node 110 moves the state machine for that client 110 to the State 1 (aborted) state. In this case, the transaction number is updated, but the data associated with the client 115 is not changed from State 0.

Update requests can be used to synchronize lagging nodes 110. Due to the fact that clients are responsible for directing state transitions related to such client, and because network reliability is not guaranteed, it is possible that not all nodes 110 will be able to be participate in a given state transition. Nodes 110 which do not participate will have a most recent state that is lagging; i.e., the transaction number for a given client 115 on such node 110 will be lower than the transaction number advanced to by a sufficient number of other nodes 110 (e.g., by a majority of other nodes). A node 110 that is lagging cannot participate in consensus or further state transitions until it has been updated. To update such a node 110, the client 115 communicates a request of its associated current state from a sufficient number of nodes 110 (e.g., from a majority of nodes). The state held by this number of nodes (e.g., majority) represents the most recent state. These nodes 110 communicate a signature confirming the current state to the client 115. The client 115 collates the signatures and sends an update to the lagging nodes with the collated signatures. Verification will, at a minimum, result in the increment of the transition number to the current transition number on the lagging nodes 110. It may also result in the update of any data associated with the client account if such an update was part of the state transition requested by the client 115.

In some cases, if a lagging node 110 is lagging by more than a single transaction, the update can involve skipping intermediate transaction numbers. In the case of client data being stored in a cryptographically linked data structure, such as a hash chain, achieving data integrity will then require that the client also update the data associated with the client account transaction by transaction, for each of the skipped transaction numbers. This is also true in applications which do not use a cryptographically linked data structure, but in which it is desirable to have a complete record of all transactions stored at every node. In both cases, this approach will require supplemental data transfers to get this data from the majority of nodes; which have the complete data history available to them. These data transfers may be managed by the client or by the node, as is most advantageous in the particular circumstances, using the cryptographic signature collation scheme and the same state machine described herein.

The total effect of using a state machine for each client 115 across all the nodes 110 is to advantageously create a network that is asynchronous byzantine fault tolerant, resilient to failures of less than a sufficient majority of nodes, and can recover from the failure of a large number of nodes (as soon as a sufficient number of such nodes themselves recover). Additionally, such approach is immune to data alteration by any entity controlling less than a sufficient number of nodes (e.g., a majority of nodes), and it becomes effectively impossible for any such entity to prevent the advance of state given that a client intends to see that state advanced. Given sufficiently distributed implementation, this approach can be considered to have substantial durability. It is also effectively impossible for the state machine to enter a deadlocked or livelocked state from which a client cannot recover, and so the system 100, as a whole, can be expected to run indefinitely. Given a suitable admission policy governing membership of nodes 110, the system 100 is robust to the addition and deletion of nodes 110. Given sufficient distribution and/or independence of nodes 110, the system 100 as a whole will have the property of distributed trust.

The system 100 can be applied to any distributed network application that requires an Asynchronous Byzantine Fault Tolerant network; for example, maintenance of a distributed ledger, an Atomic, Consistent, Independent Durable (ACID) database, a blockchain, or has a directed acyclic graph data structure.

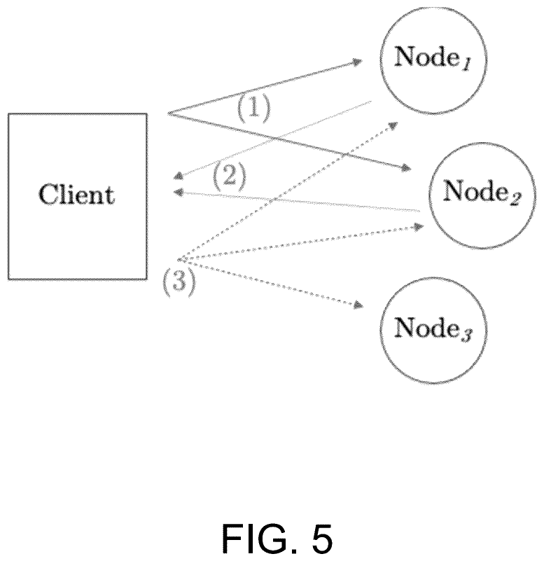

FIG. 5 shows an example of communications between a client 115 and a set of nodes 110 as the client 115 leads the nodes 110 through a transaction sequence. In step (1), the client 115 sends a Precommit request to each node 110. In step (2), the client 115 receives signatures verifying that each node 110 has entered the Precommit state. In step (3), the client 115 communicates the collated list of signatures to the node 110 s. On completion of this sequence, the state associated with the client 115 will be advanced on each node 110.

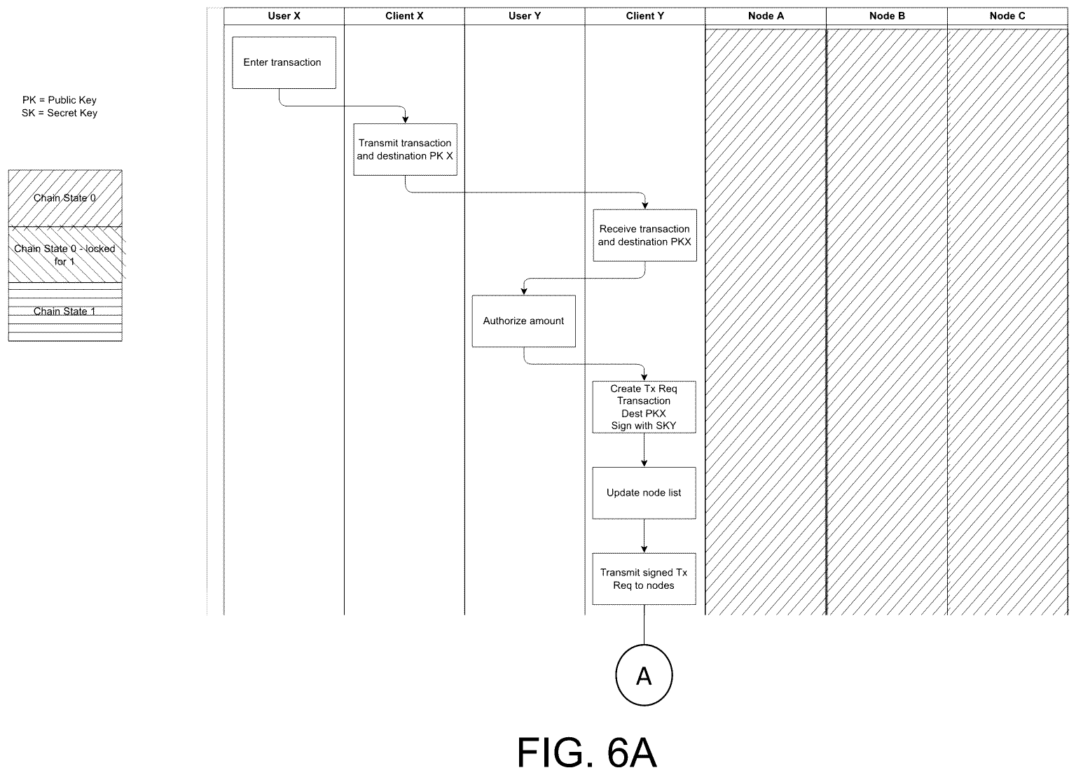

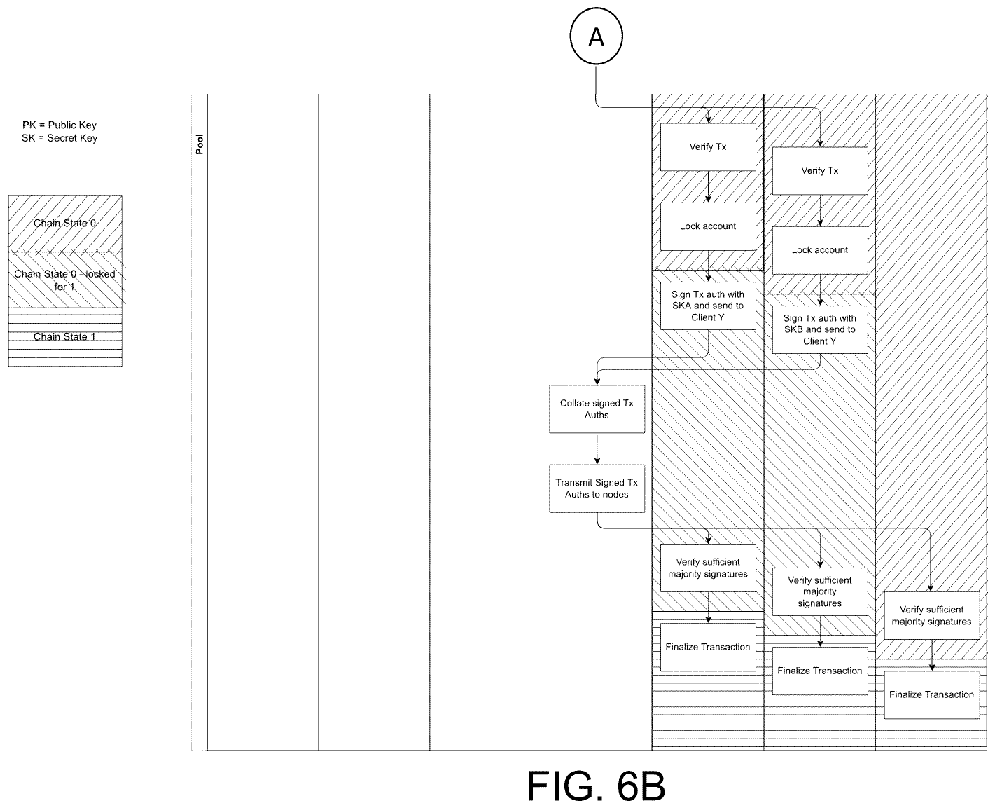

FIGS. 6A and 6B show a flowchart of an example sequence for a negotiated transaction. Client accounts for users ‘X’ and ‘Y’ are designated by public keys PK X and PK Y, respectively, for which the users control the secret keys SK X and SK Y, respectively. The clients control their respective public keys (PK) and secret keys (SK). In this example, User X is requesting a transaction from User Y, who then approves the transaction.

In this example, User X enters the transaction request into their computing device, Client X. Client X communicates the request to client Y, which presents the request to User Y as a cryptographically signed message. Client Y verifies the signature and presents the transaction to User Y who approves it. Client Y creates a transaction request, including the public key of User X (PK X) and cryptographically signs the request with User Y's secret key (SK Y).

In order to distribute transaction requests to the nodes of the network, Client Y should have a list of nodes, including the addresses required to reach them and their respective public keys. Such a list may be kept by the nodes of the network through the network validation round; which, as part of its operation, distributes among the nodes the addresses and public keys of any node that has joined or rejoined the network, and which confirms the continued operation of all nodes that are already on the list, removing any that do not respond. Clients may access this list by, for example, direct request to a node or by a separate channel. The separate channel may be through published network addresses on conventional internet ports, through other direct network connections, through a distributed database such as Bittorrent, through a distributed blockchain system such as Ethereum, through posting to verified web pages, through internet relay chat (IRC) clients, or by other broadcast means. Given this list, Client Y can then transmit the signed transaction request to the nodes of the network. In the above example, Node A and Node B receive the request, but Node C does not.

Nodes A and B verify that the transaction is valid, and enter the Precommit state. This locks the state for Client Y against further Precommit requests at these nodes. Nodes A and B sign the transaction authentication with their secret keys (SK A and SK B) and communicate it back to Client Y.

Client Y collates the signed authentications and communicates them to Nodes A, B, and C. Note that Node C can update its state directly, without transitioning the state machine, as it has received proof that a sufficient majority of the nodes are also making this transition. Nodes A, B, and C verify the signatures using the appropriate public keys and, on verification, finalize the transaction.

Note that in this example, it would be possible to submit a different Precommit request to Node C and receive an authorization for a different transaction. Node C would then be locked for this transaction on its state machine. However, this transaction would not be able to be finalized, as a sufficient majority of other authorizations could not be assembled for it, as both node A and node B are locked for the original transaction and cannot accept another one. At this point, the client would have to finish the transaction on node A and node B, and then communicate to node C an Update request, including signed authentications from node A and node B as to their current state.

Although the invention has been described with reference to certain specific embodiments, various other aspects, advantages and modifications thereof will be apparent to those skilled in the art without departing from the spirit and scope of the invention as outlined in the claims appended hereto.

1. A method for organizing operation of a distributed network, the distributed network comprising a plurality of nodes and a plurality of clients in communication, the method executed on at least one of a computing device of one or more of the nodes, a computing device of one or more of the clients, or another computing device, the method comprising:
directing each client, which desires to transition a state associated with the client, to communicate a request for state transition to the nodes;
directing the nodes to evaluate the validity of each request received from each client;
directing each node, which has validated the request, to change a state associated with the clients that sent the validated request to a pre-commitment state, and communicate to the client, which communicated the validated request, a signed acknowledgement that the request has been validated;
directing the clients that received signed acknowledgments to collate all the signed acknowledgments received from the nodes;
where the client has collated signed acknowledgments from at least a predetermined s of nodes, directing the client to communicate the collated acknowledgements to the nodes; and
directing each node to advance the state associated with each client that communicated collated acknowledgements from the pre-commitment state to a next state.

2. The method of claim 1, wherein the predetermined number of nodes comprises a sufficient majority as determined under a byzantine fault tolerant or asynchronous byzantine fault tolerant consensus scheme.

3. The method of claim 1, wherein a history of states for each client is recorded in a cryptographically linked hash chain, merkle structure, or graph.

4. The method of claim 1, wherein the state of each client is maintained on at least a portion of the nodes based on a token account.

5. The method of claim 1, wherein state transitions are charged against the token account at a fixed rate or at a rate based on computing work or resources.

6. The method of claim 1, wherein the nodes are assigned into shards, each shard maintaining states for a subset of the clients of the distributed network.

7. The method of claim 1, wherein where state transitions are divided into sending and receiving halves, and wherein the receiving halves are buffered on the nodes against the state of the client that is desirous to transition the state.

8. The method of claim 1, wherein directing the nodes to evaluate the validity of each request received from each client comprises using an ACID (atomicity, consistency, isolation, durability) paradigm.

9. The method of claim 1, wherein the state transitions can include Precommit, Preabort, Update, Commit, or Abort.

10. A method for operating a node on a distributed network, the node executed on a computing device, the method comprising:
receiving a state transition request associated with a client on the distributed network;
evaluating the validity of the request received from the client;
where the request is valid, changing a state associated with the client to a pre-commitment state, and communicating a signed acknowledgement that the request has been validated to the client;
receiving, from the client, collated acknowledgements from at least a predetermined number of nodes; and
advancing the state associated with the client from the pre-commitment state to a next state.

11. The method of claim 10, wherein the predetermined number of nodes comprises a sufficient majority as determined under a byzantine fault tolerant or asynchronous byzantine fault tolerant consensus scheme.

12. The method of claim 10, wherein state transitions are charged against a token account associated with the client at a fixed rate or at a rate based on computing work or resources.

13. The method of claim 10, wherein the node is assigned a shard, where each shard maintains states for a subset of the clients of the distributed network.

14. The method of claim 10, wherein where state transitions are divided into sending and receiving halves, and wherein the receiving halves are buffered on the node against the state of the client.

15. The method of claim 10, wherein evaluating the validity of the request comprises using an ACID (atomicity, consistency, isolation, durability) paradigm.

16. The method of claim 10, wherein the state transitions can include Precommit, Preabort, Update, Commit, or Abort.

17. A method for operating a client on a distributed network, the client executed on a computing device, the method comprising:
where the client desires to transition a state associated with the client, communicating a request for state transition to nodes on the distributed network;
received a signed acknowledgement that the state transition request has been validated from a plurality of the nodes;
where signed acknowledgments have been received from at least a predetermined number of nodes, collating the signed acknowledgments received from the plurality of nodes; and
communicating the collated acknowledgements to the nodes to advance the state associated with the client to a next state.

18. The method of claim 17, wherein state transitions are divided into sending and receiving halves, and wherein the receiving halves are buffered on the nodes against the state of the client.

19. The method of claim 17, wherein a history of states for the client is recorded in a cryptographically linked hash chain, merkle structure, or graph.

20. A distributed network comprising nodes and clients, the distributed network organized in accordance with the method of claim 1.
